(19) United States
(12) Patent Application Publication
(10) Pub. No.: US 2020/0156625 A1
(43) Pub. Date: May 21, 2020

(54) PARKING CONTROL DEVICE AND METHOD

(71) Applicant: HITACHI AUTOMOTIVE SYSTEMS, LTD., Hitachinaka-shi, Ibaraki (JP)

(72) Inventors: Yusuke KOGURE, Hitachinaka-shi, Ibaraki (JP); Takashi TSUTSUI, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/634,492

(22) PCT Filed: Jul. 3, 2018
(86) PCT No.: PCT/JP2018/025143

§ 371 Date: Jan. 27, 2020

(30) Foreign Application Priority Data
Aug. 7, 2017 (JP) 2017-152761

(51) Int. Cl. B60W 30/06; G06K 9/00; B60W 50/14

(52) U.S. Cl. CPC B60W 30/06; B60W 50/14; G06K 9/00812

(57) ABSTRACT

A parking control device and a parking control method capable of improving convenience are proposed. A parking candidate space that is a candidate of a parking destination of a vehicle is searched for based on information acquired by a surrounding environment recognition sensor, and a driver is notified of certainty of the parking candidate space detected being available for parking the vehicle in multiple stages and predetermined control processing for causing the vehicle to be parked in the parking candidate space is executed when an instruction to park the vehicle in the parking candidate space is issued from the driver.

### TECHNICAL FIELD

The present invention relates to a parking control device and method that are suitable for a parking control device that detects a space to be a candidate of a parking destination of a vehicle based on information acquired by a surrounding environment recognition sensor such as a camera and a sonar, and controls an operation of parking the vehicle in the space detected.

### BACKGROUND ART

In recent years, in relation to automobile technology, a parking control system that implements automatic control for all parking operations including acceleration, braking, steering, and gear shift has been under development. Vehicles actually equipped with such a parking control system have been put into the market.

In relation to such a parking control system, PTL 1 described below discloses a parking control device that sets at least one candidate position to be a candidate of a target position of a traveling route of a vehicle based on at least one of a result of detecting an obstacle and a result of detecting a parking boundary, sets a direction of the vehicle at each candidate position based on at least one of a result of detecting an obstacle and a result of detecting a parking boundary, ranks each candidate position based on a direction of the host vehicle and the direction of the vehicle at the candidate parking position, and determines one of the ranked candidate positions as the target position.

### CITATION LIST

### Patent Literature

PTL 1: JP 2016-60243 A

### SUMMARY OF INVENTION

### Technical Problem

When a vehicle equipped with a parking control system actually performs automatic parking, it is desired that the vehicle be parked naturally without making the driver to feel uncomfortable. If the vehicle can be parked naturally without making the driver to feel uncomfortable, the usability of the parking control system can be improved.

The present invention is made in view of the above, and an object of the present invention is to provide a parking control device and a parking control method capable of improving the usability.

### Solution to Problem

To achieve the above-described object, according to the present invention, a parking control device for controlling a parking operation of the vehicle includes a search unit that searches for a parking candidate space that is a candidate of a parking destination of the vehicle based on information acquired by a surrounding environment recognition sensor, and a control unit that notifies a driver of certainty of the parking candidate space detected by the search unit being available for parking the vehicle in multiple stages and executes predetermined control processing for causing the vehicle to be parked in the parking candidate space when an instruction to park the vehicle in the parking candidate space is issued from the driver.

In the present invention, a parking control method executed by a parking control device for controlling a parking operation of the vehicle includes a first step of searching for a parking candidate space that is a candidate of a parking destination of the vehicle based on information acquired by a surrounding environment recognition sensor, and a second step of notifying a driver of certainty of the parking candidate space detected being available for parking the vehicle in multiple stages and executing predetermined control processing for causing the vehicle to be parked in the parking candidate space when an instruction to park the vehicle in the parking candidate space is issued from the driver.

With the parking control system and the parking control method of the present invention, the vehicle can be parked naturally without making the driver feel uncomfortable.

### Advantageous Effects of Invention

The present invention can provide a parking control system and a parking control method which can improve the usability.

### BRIEF DESCRIPTION OF DRAWINGS

FIG. 1 is a diagram used for explanation of a conventional parking control system.

FIG. 2 is a schematic diagram schematically illustrating a configuration of a vehicle equipped with a parking control system according to the present embodiment.

FIG. 3 is a block diagram illustrating a configuration of an ECU according to the present embodiment.

FIG. 4 is a diagram illustrating a display example of a bird's eye view image displayed on a display device of a navigation system during a first stage of a parking control function according to the present embodiment.

FIG. 5 is a diagram used for explanation of the first stage of the parking control function according to the present embodiment.

FIG. 6 is a diagram used for explanation of a second stage of the parking control function according to the present embodiment.

FIG. 7 is a diagram illustrating a display example of a bird's eye view image displayed on a display device of a navigation system during the second stage of the parking control function according to the present embodiment.

FIG. 8 is a diagram used for explanation of a third stage of the parking control function according to the present embodiment.

FIG. 9 is a diagram illustrating a display example of a bird's eye view image displayed on a display device of a navigation system during the third stage of the parking control function according to the present embodiment.

FIG. 10 is a flowchart illustrating a processing procedure of parking control processing.

### DESCRIPTION OF EMBODIMENTS

Hereinafter, an embodiment of the present invention will be described in detail with reference to the drawings.

### (1) Conventional Parking Control System

First of all, a conventional parking control system is described for describing a parking control system according to the present embodiment.

A conventionally proposed parking control system detects a parking space in which a host vehicle can be parked by using a surrounding environment recognition sensor, such as a sonar and a camera installed on the vehicle, acquiring information required for recognizing the surrounding environment of the vehicle, and causes the host vehicle to be moved by automatic driving into the detected parking space so that the vehicle is parked.

In fact, in such a parking control system, for example, when a parking control mode is set in a parking lot of a supermarket and the like, a space that can be a candidate for a parking destination of the host vehicle (hereinafter, referred to as a parking candidate space) is searched for by using the surrounding environment recognition sensor installed in the vehicle.

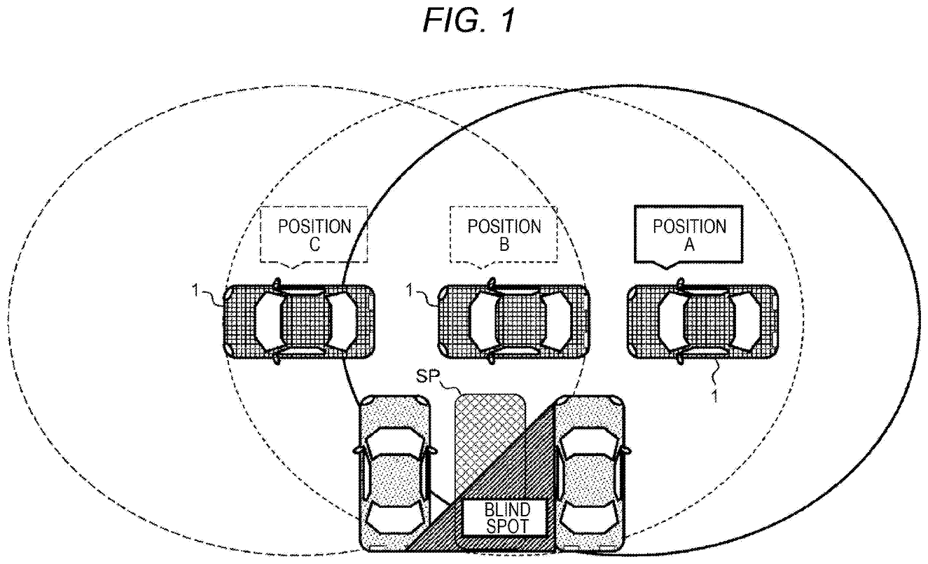

Then, upon detecting such a parking candidate space SP at a position A in FIG. 1, the parking control system directly moves the host vehicle 1 to a position B that is in front of the parking candidate space SP, and determines whether the parking candidate space SP include an obstacle.

Furthermore, when a result of the determination indicates that the host vehicle 1 can be certainly parked in the parking candidate space SP, the parking control system causes the host vehicle 1 to move forward to a position C beyond the parking candidate space SP. Then, the parking control system calculates a parking route of the host vehicle 1, and causes the host vehicle 1 to move along the calculated parking route to be parked in the parking candidate space SP.

However, generally, a driver driving the vehicle starts turning to be in a parking operation upon confirming that the parking candidate space SP includes no obstacle while being at the position B. Thus, the driver feels uncomfortable when the parking operation starts only after the host vehicle 1 has moved to the position C as described above, instead of starting while the host vehicle 1 is at the position B.

Thus, in the present embodiment, a parking control system is proposed in which the host vehicle can execute a natural parking operation without causing the driver to feel uncomfortable as described above. Hereinafter, this parking control system according to the present embodiment will be described.

### (2) Configuration of Parking Control System According to the Present Embodiment

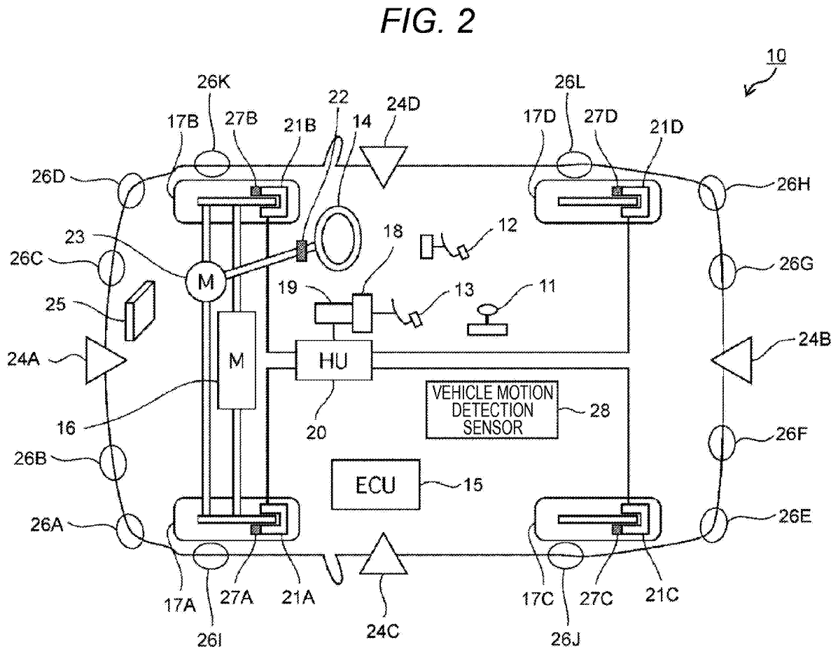

In FIG. 2, reference numeral 10 denotes the entirety of a vehicle in which the parking control system according to the present embodiment is installed. In this host vehicle 10, a shift lever 11, an accelerator pedal 12, a brake pedal 13, a steering wheel 14, and an ECU 15 are arranged at predetermined positions in a vehicle cabin where a driver gets on.

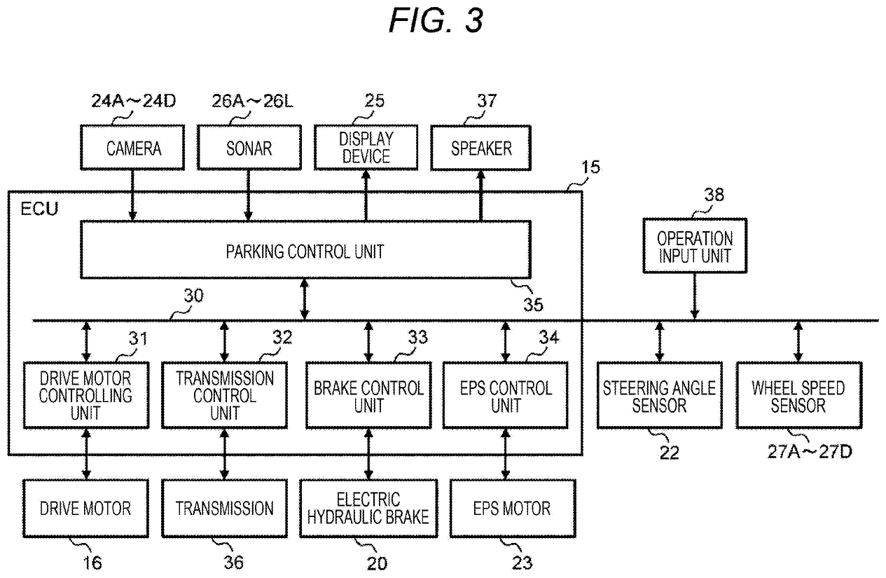

The shift lever 11 is an operator used by the driver to switch the gear combination of a transmission 36 (FIG. 3). The driver instructs the vehicle to move forward or backward by operating the shift lever 11. The transmission 36 can switch the gear combination under the control of the ECU 15 regardless of the operation on the shift lever 11 by the driver.

The accelerator pedal 12 is an operator for controlling power output from a drive motor 16 that is a power source of the host vehicle 10, and is operated by the driver stepping on the accelerator pedal 12 by his or her foot. The driver's pedal force on the accelerator pedal 12 is transmitted to the ECU 15, and under the control of the ECU 15, torque of a magnitude corresponding to the pedal force is output from the drive motor 16 and transmitted to wheels 17A and 17B. It should also be noted that the drive motor 16 can operate and output torque under the control of the ECU 15 regardless of the operation on the accelerator pedal 12 by the driver. An engine (internal combustion engine) may be used as a power source for the host vehicle 10 instead of or in addition to the drive motor 16.

The brake pedal 13 is an operator for braking the host vehicle 10, and, as in the case of the accelerator pedal 12, is operated by the driver stepping on the brake pedal 13 with his or her foot. The driver's pedal force on the brake pedal 13 is boosted by a brake booster 18, and hydraulic pressure corresponding to the magnitude of the boosted pedal force is generated in a master cylinder 19. This hydraulic pressure is supplied to wheel cylinders 21A to 21D via an electric hydraulic brake 20, and braking force corresponding to the hydraulic pressure is generated by the wheel cylinders 21A to 21D. Note that the electric hydraulic brake 20 can generate the braking force by operating the wheel cylinders 21A to 21D under the control of the ECU 15, regardless of the operation on the brake pedal 13 by the driver.

The steering wheel 14 is an operator on which a rotational operation is performed by the driver for adjusting the traveling direction of the host vehicle 10. The amount of the rotational operation on the steering wheel 14 is detected as a steering angle by a steering angle sensor 22 and provided in notification to the electric power steering motor 23. Then, assist torque corresponding to the steering angle is generated from the electric power steering motor 23. The direction of steered wheels (left and right front wheels 17A and 17B) is changed by the steering torque given to the steering wheel 14 by the driver and the assist torque generated from the electric power steering motor 23. As a result, the traveling direction of the vehicle changes. Note that the electric power steering motor 23 can change the direction of the steered wheels by generating assist torque under the control of the ECU 15 regardless of the rotational operation on the steering wheel 14 by the driver.

Cameras 24A to 24D serving as environment recognition sensors are respectively attached to the front, rear, left and right of the host vehicle 10. When the host vehicle 10 performs a backward driving operation, images based on image information output from the four cameras 24A to 24D are combined by the ECU 15 so that a bird's eye view image in which the host vehicle 10 and its surroundings are looked down from above is generated. The bird's eye view image thus generated is displayed on a display device 25 of the car navigation system, for example. Thus, the driver can perform the parking operation for the host vehicle while viewing the bird's eye view image.

Furthermore, sonars 26A to 26L, serving as environment recognition sensors, detecting obstacles around the host vehicle 10 and measuring the distance to the detected obstacle are arranged on the front, rear, left and right of the host vehicle 10. The detection result and measurement result of the sonars 26A to 26L are given to the ECU 15. Thus, the ECU 15 can recognize whether there is an obstacle around the host vehicle 10 based on the detection and measurement results from the sonars 26A to 26L.

The ECU 15 is a computer device that controls the drive motor 16 so as to output torque corresponding to the pedal force when the driver steps on the accelerator pedal 12. The ECU 15 also performs control for antiskid braking and antilock braking for the host vehicle 10 by controlling the electric hydraulic brake 20 based on outputs from the steering angle sensor 22 described above that detects the rotation amount of the steering wheel 14, vehicle speed sensors 27A to 27D respectively provided close to the wheels 17A to 17D to detect the rotation speed of the wheels 17A to 17D, and a vehicle motion detection sensor 28 that detects acceleration in a front and back direction, lateral acceleration, and a yaw rate.

In addition to such a configuration, the ECU 15 according to the present embodiment has a parking control function of searching for a space (parking candidate space) to be a candidate of a parking destination of the host vehicle 10 based on the image information output from each of the cameras 24A to 24D and sensor information output from each of the sonars 26A to 26L, and of controlling the drive motor 16, the transmission 36, the electric hydraulic brake 20, and the electric power steering motor 23 to make the host vehicle 10 move into the parking candidate space detected by the search to be parked in the space.

One feature of the parking control function of the present embodiment is that after the parking candidate space has been detected, the driver is notified of a certainty of the parking candidate space being available for parking the host vehicle 10 in multiple stages, and the parking control starts causing the host vehicle 10 to move into the parking candidate space when the driver issues an instruction for causing the host vehicle to be parked in the parking candidate space.

As units for implementing such a parking control function according to the present embodiment, the ECU 15 of the present embodiment includes, as illustrated in FIG. 3, a drive motor controlling unit 31, a transmission control unit 32, a brake control unit 33, an Electronic Power Steering (EPS) control unit 34, and a parking control unit 35 connected to each other via an in-vehicle network 30.

The drive motor controlling unit 31 is a functional unit having a function of controlling the drive motor 16 generating and outputting, in accordance with a magnitude of the pedal force applied to the accelerator pedal 12 by the driver and a request from the parking control unit 35, torque corresponding to the pedal force or the request. Furthermore, the transmission control unit 32 is a functional unit having a function of switching, in accordance with an operation on the shift lever 11 by the driver or a request from the parking control unit 35, a combination of gears in the transmission 36 to a combination corresponding to the operation or the request.

The brake control unit 33 is a functional unit having a function of controlling, in accordance with the magnitude of the pedal force applied to the brake pedal 13 by the driver or a request from the parking control unit 35, the electric hydraulic brake 20 to generate the braking force corresponding to the pedal force or the request. The EPS control unit 34 is a functional unit having a function of controlling, in accordance with the rotational operation applied to the steering wheel 14 from the driver or a request from the parking control unit 35, the electric power steering motor 23 to generate the assist force corresponding to the rotational angle of the steering wheel 14 or the request.

The parking control unit 35 is a functional unit having a function of controlling each of the drive motor 16, the transmission 36, the electric hydraulic brake 20, and the electric power steering motor 23 at a necessary timing as appropriate to implement the parking control function according to the present embodiment described above.

In practice, when a parking control mode is set in a parking lot for a supermarket and the like, the parking control unit 35 checks that there is no obstacle or the like around the host vehicle 10 based on the image information provided from each of the cameras 24A to 24D and the sensor information provided from each of the sonars 26A to 26L, and causes the host vehicle 10 to be automatically driven to slowly move by controlling each of the drive motor 16, the transmission 36, the electric hydraulic brake 20, and the electric power steering motor 23 via the drive motor controlling unit 31, the transmission control unit 32, the brake control unit 33 or the EPS control unit 34 at a necessary timing as appropriate.

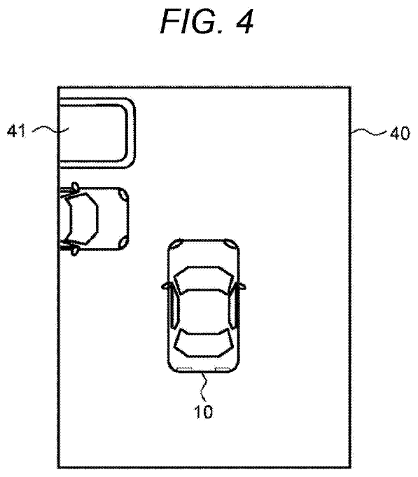

In this process, the parking control unit 35 waits for a parking space (parking candidate space) with no vehicle parked therein to appear on a front side of the host vehicle 10 in the traveling direction, based on the image information output from the camera 24A provided on the front side of the vehicle body of the host vehicle 10. Furthermore, in this process, the parking control unit 35 causes the display device 25 of the navigation system to display, for example, a bird's eye view image 40 as illustrated in FIG. 4 generated based on the image information provided from the cameras 24A to 24D.

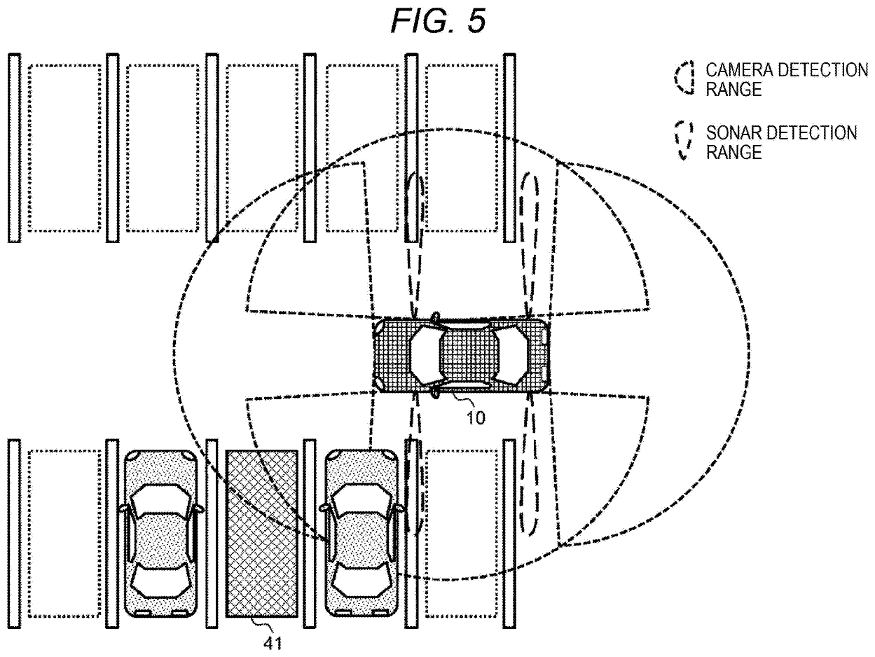

Upon detecting such a parking candidate space 41 at the point when the host vehicle 10 has advanced to the position illustrated in FIG. 5 (hereinafter, this state is referred to as the first stage), for example, the parking control unit 35 causes a speaker 37 (FIG. 3) to output a predetermined first guide voice such as “seems to be available for parking” and also causes the parking candidate space 41 in the bird's eye view image 40 as illustrated in FIG. 4 displayed on the display device 25 of the navigation system to be colored with a first predetermined color such as yellow to be highlighted. In this manner, the parking control unit 35 can notify the driver of the fact that the parking candidate space 41 should be available for parking the host vehicle 10 but the certainty that the host vehicle 10 can be parked in the parking candidate space 41 is still low.

Thereafter, the parking control unit 35 continues to cause the host vehicle 10 to move slowly, while waiting, only for a first predetermined period (hereinafter, referred to as a first driver intention confirmation period), for an instruction to park the host vehicle 10 in the parking candidate space 41 to be issued from the driver. The instruction is issued through words such as “park here” or a predetermined operation on a predetermined operation input unit 38 (FIG. 3) such as a switch.

When the driver issues the instruction to park the host vehicle 10 in the parking candidate space 41 during the first driver intention confirmation period, the parking control unit 35 controls each of the drive motor 16, the transmission 36, the electric hydraulic brake 20 and the electric power steering motor 23 via the drive motor controlling unit 31, the transmission control unit 32, the brake control unit 33, or the EPS control unit 34 at a necessary timing as appropriate, to cause the host vehicle 10 to move into the parking candidate space 41 to be parked in the parking candidate space 41.

On the other hand, when the driver does not issue the instruction to park the host vehicle 10 in the parking candidate space 41 within the first driver intention confirmation period, the parking control unit 35 continues to cause the host vehicle 10 to move slowly.

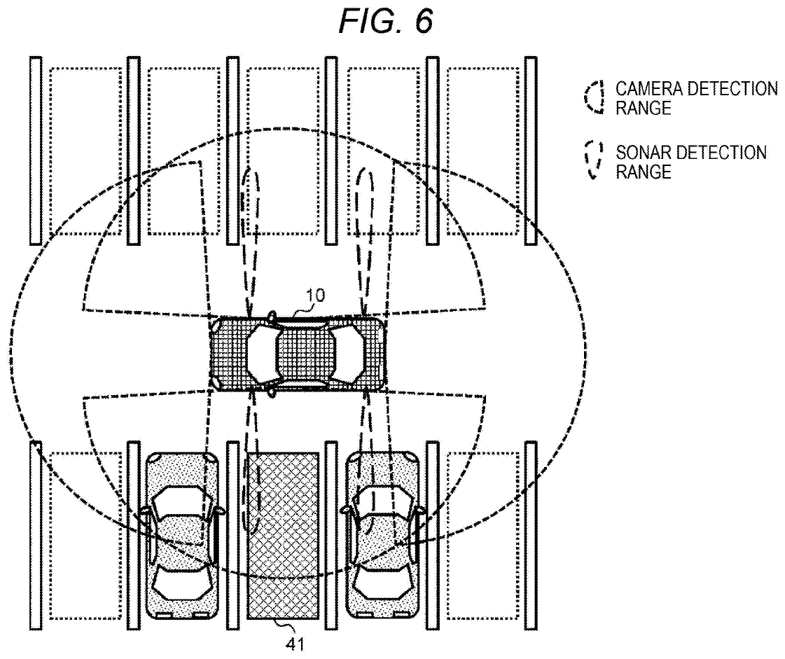

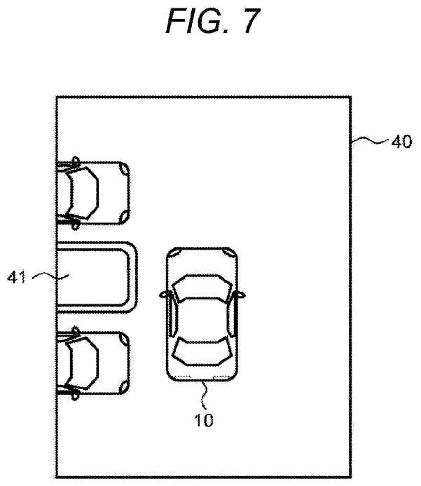

Thereafter, upon recognizing that, with the host vehicle 10 advanced to the position illustrated in FIG. 6, the parking candidate space 41 includes no obstacle so that the host vehicle 10 can be certainly parked in the parking candidate space 41 if a parking route described later can be generated based on sensor signals from the sonars 26A to 26L (hereinafter, this state is referred to as a second stage), the parking control unit 35 causes the speaker 37 (FIG. 3) to output a predetermined second guide voice such as “space is available for parking” and also colors the parking candidate space 41 in the bird's eye view image 40 as illustrated in FIG. 7 displayed by the display device 25 of the navigation system with a second predetermined color (green for example) different from that in the first stage described above to be highlighted. In this way, the parking control unit 35 notifies the driver that the certainty that the host vehicle 10 can be parked in the parking candidate space 41 is medium.

Thereafter, the parking control unit 35 continues to cause the host vehicle 10 to move slowly, while waiting, only for a second predetermined period (hereinafter, referred to as a second driver intention confirmation period), for an instruction to cause the host vehicle 10 to park the host vehicle 10 in the parking candidate space 41 to be issued from the driver. The instruction is issued through words such as “park there” or a predetermined operation on a predetermined operation input unit 38 (FIG. 3).

When the driver issues the instruction to park the host vehicle 10 in the parking candidate space 41 during the second driver intention confirmation period, the parking control unit 35 controls each of the drive motor 16, the transmission 36, the electric hydraulic brake 20 and the electric power steering motor 23 via the drive motor controlling unit 31, the transmission control unit 32, the brake control unit 33, or the EPS control unit 34 at a necessary timing as appropriate, to cause the host vehicle 10 to move into the parking candidate space 41 to be parked in the parking candidate space 41.

On the other hand, when the driver does not issue the instruction to park the host vehicle 10 in the parking candidate space 41 within the second driver intention confirmation period, the parking control unit 35 calculates the parking route along which the host vehicle 10 moves into the parking candidate space 41, while continuing to cause the host vehicle 10 to move slowly.

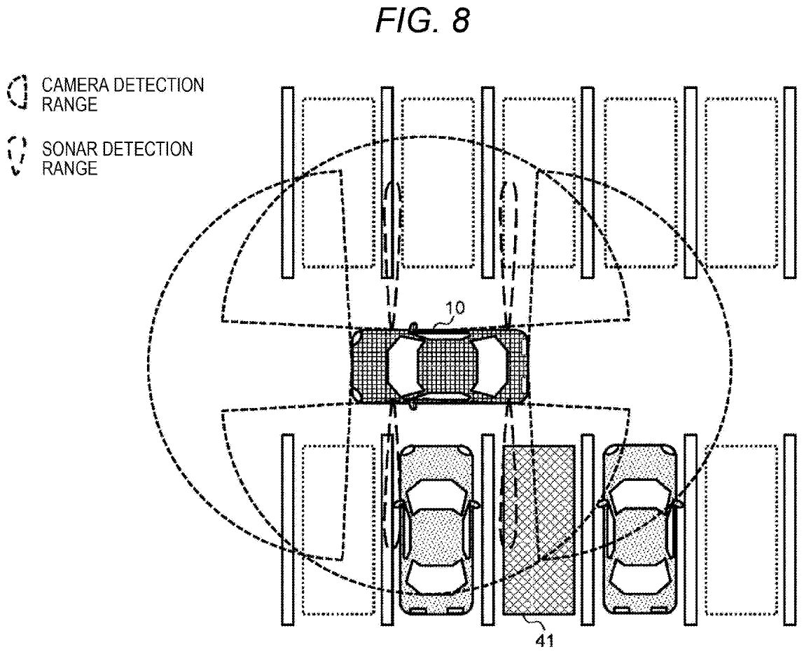

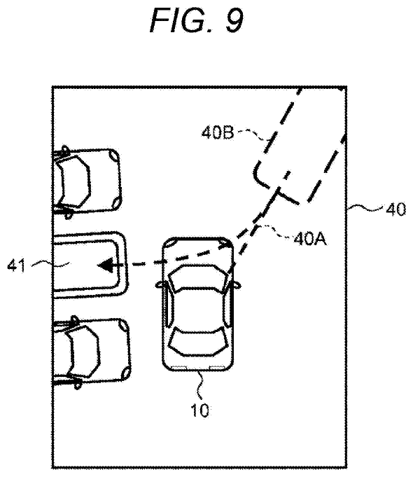

Upon completing the calculation of the parking route (generation of the parking route) with the vehicle advanced to a position illustrated in FIG. 8 (hereinafter, this state is referred to as a third stage), the parking control unit 35 causes the speaker 37 (FIG. 3) to output a predetermined third guide voice such as “you can park here” and also colors the parking candidate space 41 in the bird's eye view image 40 as illustrated in FIG. 9 displayed on the display device 25 of the navigation system with a third predetermined color (blue for example) different from the first or the second predetermined color described above to be highlighted. In this way, the parking control unit 35 notifies the driver that the certainty that the host vehicle can be parked in the parking candidate space 41 is high.

Also, at this time, as illustrated in FIG. 9, the parking control unit 35 displays a dotted line 40A, on the bird's eye view image 40, indicating the parking route generated as described above and a dotted line 40B indicating a position at which the host vehicle 10 is switched back to move along the parking route.

Thereafter, the parking control unit 35 causes the host vehicle 10 to temporarily stop at the position, while waiting, only for a third predetermined period (hereinafter, referred to as a third driver intention confirmation period), for the instruction to park the host vehicle 10 in the parking candidate space 41 to be issued from the driver. The instruction is issued through words such as “park there” or a predetermined operation on a predetermined operation input unit 38 (FIG. 3).

When the driver provides the instruction to park the host vehicle 10 in the parking candidate space 41 during the third driver intention confirmation period, the parking control unit 35 controls each of the drive motor 16, the transmission 36, the electric hydraulic brake 20 and the electric power steering motor 23 via the drive motor controlling unit 31, the transmission control unit 32, the brake control unit 33, or the EPS control unit 34 at a necessary timing as appropriate, to cause the host vehicle 10 to move into the parking candidate space 41 to be parked in the parking candidate space 41.

On the other hand, when the driver does not issue the instruction to park the host vehicle 10 in the parking candidate space 41 during the third driver intention confirmation period, the parking control unit 35 ends the processing for causing the host vehicle 10 to be parked in the parking candidate space 41. Then, the parking control unit 35 causes the host vehicle 10 to move slowly again and waits for the next parking candidate space 41 to be detected. Then, the processing as described above is repeated until the parking control mode is cancelled or the host vehicle 10 is parked in any of the parking candidate spaces 41.

### (3) Parking Control Processing

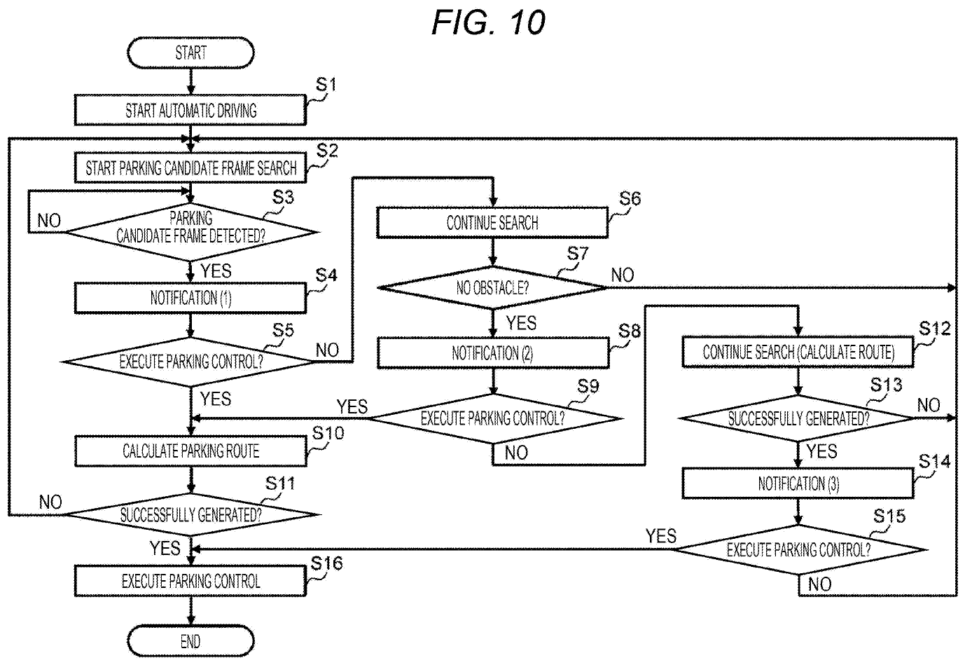

FIG. 10 illustrates a specific processing procedure of the parking control processing described above executed by the parking control unit 35 (FIG. 3) of the ECU 15 (FIG. 3) in relation to the parking control function.

When the parking control mode is set, the parking control unit 35 starts the parking control processing illustrated in FIG. 10. First of all, the parking control unit 35 starts the automatic driving of the host vehicle 10, and also causes the display device 25 (FIG. 3) of the navigation system to display the above-described bird's eye view image 40 (FIG. 4 and the like) based on the image information output from the each of the cameras 24A to 24D (S1).

Then, the parking control unit 35 starts searching for a parking space (parking candidate space 41) in which no other vehicle is parked (S2), and executes image recognition processing on the image based on the image information from the camera 24A provided on the vehicle front side of the host vehicle 10 to wait for the parking candidate space 41 to appear in the image (S3).

Then, upon detecting the parking candidate space 41, as described above with reference to FIG. 4 and FIG. 5, the parking control unit 35 causes the speaker 37 (FIG. 3) to output the first guide voice and colors the parking candidate space 41 in the bird's eye view image 40 displayed on the display device 25 of the navigation system with the first predetermined color to be highlighted (S4).

Then, the parking control unit 35 waits for the instruction from the driver to be issued during the first driver intention confirmation period described above. When the driver issues the instruction for parking the host vehicle 10 in the parking candidate space 41 during the first driver intention confirmation period (S5: YES), the parking control unit 35 executes calculation processing for generating the parking route for parking the host vehicle 10 in the parking candidate space 41, based on the image information from each of the cameras 24A to 24D and the sensor signal from each of the sonars 26A to 26L (S10).

Then, the parking control unit 35 determines whether the parking route has been successfully generated by the calculation processing in step S10. When the parking route fails to be generated (S11: NO), the parking control unit 35 returns to step S2 and resumes the search for the next parking candidate space 41.

On the other hand, when the parking route is successfully generated by the calculation processing in step S10 (S1: YES), the parking control unit 35 performs parking control to control each of the drive motor 16, the transmission 36, the electric hydraulic brake 20 and the electric power steering motor 23 via the drive motor controlling unit 31, the transmission control unit 32, the brake control unit 33, or the EPS control unit 34 at a necessary timing as appropriate, to cause the host vehicle 10 to move into the parking candidate space 41 to be parked in the parking candidate space 41 (S16). Upon completing the parking of the host vehicle 10 in the parking candidate space 41, the parking control unit 35 ends the parking control processing.

On the other hand, when the instruction to park the host vehicle 10 in the parking candidate space 41 is not issued from the driver during the first driver intention confirmation period after the processing step S4 described above (S5: NO), the parking control unit 35 continues the operation for searching for the parking candidate space 41 while continuing to cause the host vehicle 10 to move slowly (S6).

At this time, the parking control unit 35 is monitoring whether the parking candidate space 41 includes an obstacle based on the sensor signal from the sonars 26A to 26L. When the parking candidate space 41 includes an obstacle (S7: NO), the parking control unit 35 returns to step S2 and resumes the search for the next parking candidate space 41.

On the other hand, when the parking candidate space 41 includes no obstacle (S7: YES), the parking control unit 35 causes the speaker 37 (FIG. 3) to output the above-described second guide voice, and colors the parking candidate space 41 in the bird's eye view image 40 (FIG. 7) displayed on the display device 25 (FIG. 3) of the navigation system with the second predetermined color to be highlighted (S8).

Thereafter, the parking control unit 35 waits for the instruction from the driver only for the second driver intention confirmation period described above. When the instruction to park the host vehicle 10 in the parking candidate space 41 is received from the driver during the second driver intention confirmation period (S9: YES), the parking control unit 35 proceeds to step S10, and executes the processing in and after step S10 as described above.

On the other hand, when the driver does not issue the instruction to park the host vehicle 10 in the parking candidate space 41 during the second driver intention confirmation period after the processing in step S9 (S9: NO), the parking control unit 35 executes calculation processing for generating the parking route for parking the host vehicle 10 in the parking candidate space 41, based on the image information from each of the cameras 24A to 24D and the sensor signal from each of the sonars 26A to 26L, while continuing to cause the host vehicle 10 to move slowly (S12).

When the parking route fails to be generated by the calculation processing in step S12 (513: NO), the parking control unit 35 returns to step S2 and resumes the search for the next parking candidate space 41.

On the other hand, when the parking route is successfully generated (S13: YES), the parking control unit 35 causes the speaker 37 (FIG. 3) to output the above-described third guide voice, and colors the parking candidate space 41 in the bird's eye view image 40 (FIG. 9) displayed on the display device 25 (FIG. 3) of the navigation system with the third predetermined color to be highlighted (514).

Thereafter, the parking control unit 35 waits for the instruction from the driver only for the third driver intention confirmation period described above. When the instruction to park the host vehicle 10 in the parking candidate space 41 is not issued from the driver during the third driver intention confirmation period (S15: NO), the parking control unit 35 returns to step S2 and resumes the search for the next parking candidate space 41.

When the instruction to park the host vehicle 10 in the parking candidate space 41 is issued from the driver during the third driver intention confirmation period (S15: YES), the parking control unit 35 executes the processing in step S16 as described above, and then ends this parking control processing.

### (4) Effects of the Present Embodiment

As described above, the parking control system of the present embodiment including the cameras 24A to 24D, the sonars 26A to 26L, and the ECU 15 notifies, upon detecting the parking candidate space 41, the driver of the certainty of the parking candidate space 41 being available for parking the host vehicle 10 in multiple stages, based on the content of the guide voice and the bird's eye and how the parking candidate space 41 is displayed in the bird's eye view image 40 displayed on the display device 25, and executes the predetermined processing of causing the vehicle 10 to be parked in the parking candidate space 41 when the instruction to park the vehicle 10 in the parking candidate space 41 is issued from the driver that has been notified of the certainty.

Thus, the present parking control system starts the parking operation at a timing according to the driver's intention, so that the parking operation of the vehicle can be performed naturally without making the driver feel uncomfortable, whereby the usability of the parking control system can be improved.

### (5) Other Embodiments

In the above-described embodiment, the cameras 24A to 24D and the sonars 26A to 26L are applied as the surrounding environment recognition sensors that acquire information necessary for recognizing the surrounding environment of the vehicle. However, the present invention is not limited to this. For example, a radar or the like may be applied in addition to or instead of the sonars 26A to 26L, and these various surrounding environment recognition sensors can be widely applied.

In the above-described embodiment, the driver is notified of the certainty of the parking candidate space 41 being available for parking the host vehicle 10, detected in the search, in three stages. However, the present invention is not limited to this. For example, the notification may be performed in two stages or four or more stages.

Furthermore, in the above-described embodiment, the certainty of the parking candidate space 41 being available for parking the host vehicle 10 detected by the search is provided in notification to the driver based on the content of the guide voice and the bird's eye and how the parking candidate space 41 is displayed in the bird's eye view image 40 displayed on the display device 25. However, the present invention is not limited to this. The driver may be notified of the certainty based on sound such as buzzer or chime, or by a color or a blinking speed of light emitted from an LED. Furthermore, other various methods can be widely applied. The contents of the guide voice are not limited to “seems to be available for parking”, “space is available for parking”, and “you can park here”, and various other like contents can be widely applied.

Furthermore, in the above-described embodiment, the certainty of the parking candidate space 41 being available for parking the host vehicle 10 detected by the search is provided in notification to the driver based on the content of the guide voice and the bird's eye and how the parking candidate space 41 is displayed in the bird's eye view image 40 displayed on the display device 25. However, the present invention is not limited to this. For example, instead of highlighting and displaying the parking candidate space 41 itself, a frame (parking frame) displayed to define parking spaces in a parking lot for a supermarket and the like may be displayed with a color corresponding to the certainty to be highlighted.

Furthermore, in the above-described embodiment, the bird's eye view image 40 in which the host vehicle 10 and its surroundings are looked down from above is displayed on the display device 25 of the navigation system. However, the present invention is not limited this. A dedicated display device may be provided separately from the display device 25 of the navigation system, to display the bird's eye view image 40 of the display device.

Furthermore, in the above-described embodiment, the operation input unit 38 (FIG. 3) is provided as a unit used by the driver to issue the instruction to park the host vehicle 10 in the parking candidate space 41 detected by the parking control unit 35 of the ECU 15 to the parking control unit 35. However, the present invention is not limited to this. For example, a touch panel type display may be used as the display device 25 of the navigation system. Thus, the driver may touch the parking candidate space 41 highlighted and displayed in the bird's eye view image 40 displayed on the display device 25 to issue the instruction to the parking control unit 35.

Furthermore, in the above-described embodiment, the parking control unit 35 of the ECU 15 is provided with functions of a search unit and a control unit. The search unit searches for a parking candidate space that is a candidate of a parking destination of a vehicle based on information acquired by a surrounding environment recognition sensor. The control unit notifies a driver of certainty of parking candidate space detected by the search unit being available for parking the vehicle in various stages and executes predetermined control processing for causing the vehicle to be parked in the parking candidate space when the instruction to park to vehicle in the parking candidate space is issued from the driver. However, the present invention is not limited to this. A unit that has the functions of both the search unit and the control unit may be provided separately from the ECU 15. Furthermore, instead of providing the functions of the search unit and the control unit to one parking control unit 35, a unit having the function of the search unit and a unit having the function of the control unit may be separately provided.

### INDUSTRIAL APPLICABILITY

The present invention can be widely applied to a parking control device that controls a parking operation for a vehicle.

### REFERENCE SIGNS LIST

1, 10 vehicle
15 ECU
16 drive motor
17A to 17D wheel
20 electric hydraulic brake
22 steering angle sensor
23 electric power steering motor
24A to 24D camera
25 display device
26A to 26L sonar
27A to 27D wheel speed sensor
28 vehicle motion detection sensor
36 transmission
37 speaker
38 operation input unit
40 bird's eye view image
41 parking candidate space

1. A parking control device for controlling a parking operation of a vehicle, the parking control device comprising:
a search unit that searches for a parking candidate space that is a candidate of a parking destination of the vehicle based on information acquired by a surrounding environment recognition sensor; and
a control unit that notifies a driver of certainty of the parking candidate space detected by the search unit being available for parking the vehicle in multiple stages and executes predetermined control processing for causing the vehicle to be parked in the parking candidate space when an instruction to park the vehicle in the parking candidate space is issued from the driver.

2. The parking control device according to claim 1, wherein
the surrounding environment recognition sensor includes at least a camera, and
the control unit
causes a predetermined display device to display an image based on image information output from the camera and highlight the parking candidate space displayed in the image, and
notifies the driver of the certainty of the parking candidate space being available for parking the vehicle, based on how the highlighting is performed.

3. The parking control device according to claim 2, wherein
the control unit notifies the driver of the certainty of the parking candidate space being available for parking the vehicle, based on a content of guide voice.

4. The parking control device according to claim 3, wherein
upon determining that the vehicle is not able to be parked in the parking candidate space after the notification unit has notified the driver of the certainty of the parking candidate space detected being available for parking the vehicle, the control unit starts searching for another parking candidate space.

5. A parking control method executed by a parking control device for controlling a parking operation of a vehicle, the parking control method comprising:
a first step of searching for a parking candidate space that is a candidate of a parking destination of the vehicle based on information acquired by a surrounding environment recognition sensor; and
a second step of notifying a driver of certainty of the parking candidate space detected being available for parking the vehicle in multiple stages and executing predetermined control processing for causing the vehicle to be parked in the parking candidate space when an instruction to park the vehicle in the parking candidate space is issued from the driver.

6. The parking control method according to claim 5, wherein
the surrounding environment recognition sensor includes at least a camera, and
in the second step,
a predetermined display device is caused to display an image based on image information output from the camera and highlight the parking candidate space displayed in the image, and
the driver is notified of the certainty of the parking candidate space being available for parking the vehicle, based on how the highlighting is performed.

7. The parking control method according to claim 6, wherein
in the second step, the driver is notified of the certainty of the parking candidate space being available for parking the vehicle, based on a content of guide voice.

8. The parking control method according to claim 7, wherein
in the second step,
upon determining that the vehicle is not able to be parked in the parking candidate space after the driver has been notified of the certainty of the parking candidate space detected being available for parking the vehicle, searching for another parking candidate space is started.
